(19) United States
(12) Patent Application Publication
(10) Pub. No.: US 2015/0306602 A1
(43) Pub. Date: Oct. 29, 2015

(54) EXFOLIATOR, EXFOLIATING APPARATUS AND EXFOLIATING METHOD

(71) Applicant: NATIONAL CHENG KUNG UNIVERSITY, Tainan City (TW)

(72) Inventors: Fu-Su YEN, TAINAN CITY (TW); Wen-Chiao HUANG, TAINAN CITY (TW); Pei-Ching YU, YILAN COUNTY (TW)

(21) Appl. No.: 14/698,857

(22) Filed: Apr. 29, 2015

(30) Foreign Application Priority Data
Apr. 29, 2014 (TW) 103115389
Feb. 17, 2015 (TW) 104105637

(51) Int. Cl. B02C 17/16; B02C 17/06

(52) U.S. Cl. CPC B02C 17/163; B02C 17/06

(57) ABSTRACT

An exfoliator, an exfoliating apparatus and an exfoliating method using the same are described. The orientating column of the exfoliator is suitable for propeling a plurality of beads. The exfoliator includes a first base, a second base, at least one first orientating column and a plurality of beads. The first base has a first central hole for allowing a rotating axis to pass therethrough. The second base has a second central through hole for allowing the rotating axis to pass therethrough. The first orientating column has two opposite ends, in which the two ends of the first orientating column are fixed to the first base and the second base respectively.

### RELATED APPLICATIONS

This application claims priorities to Taiwan Application Serial Number 103115389, filed Apr. 29, 2014, and Taiwan Application Serial Number 104105637, filed Feb. 17, 2015, both of which are herein incorporated by reference.

### BACKGROUND

1. Field of Invention

The present invention relates to a device for processing a material. More particularly, the present invention relates to an exfoliator, an exfoliating apparatus and an exfoliating method using the same.

2. Description of Related Art

A typical agitator has several plate bases and a rotating axis passing through the centers of the plate bases, so as to drive the bases to rotate along the rotating axis. A ring-shaped space is formed between the adjacent bases, for receiving several beads and a being-ground material. When the bases are rotating, the beads driven by the bases are moving and colliding with each other. The collision force generated from the collision between the beads can grind the being-ground material, resulting in a smaller size of the being-ground material.

However, the agitator is not applicable to a sheet-form material during an exfoliating operation. Since the beads are only driven by the bases, and impact forces with various directions generate during the agitating step. Such impact forces provide a uniform grinding effect on the sheet-form material, for forming granular material.

Accordingly, there is a need to provide an exfoliator, an exfoliating apparatus and an exfoliating method using the same to solve the problems that the agitator is not applicable to the sheet-form material during the exfoliating operation.

### SUMMARY

Therefore, one aspect of the present invention is to provide an exfoliator, which is applicable to a sheet-form material during an exfoliating operation.

Another aspect of the present invention is to provide an exfoliating apparatus, which can drive an exfoliator through a rotation device to propel beads in a chamber. All beads in the chamber perform a circumferential movement along a rotating axis, and each bead performs self-rotation independently along a self-rotating axis at the same time. A shearing force is generated from every two adjacent beads due to a difference of an angular speed between the two beads. Then, a laminated and sheet-form material can be exfoliated in flake-by-flake manner through the aforementioned shearing force.

A further aspect of the present invention is to provide an exfoliating method, which can increase a probability of the formation of the shearing force during the contact between the beads, so as to achieve an exfoliating effect to a laminated material.

According to the aforementioned aspects, the exfoliator including a first base, a second base, at least one first orientating column and a plurality of beads is provided. The first base has a first central hole for allowing a rotating axis to pass therethrough. The second base has a second central hole for allowing the rotating axis to pass therethrough. The first orientating column has two opposite ends, in which the two opposite ends are fixed to the first base and the second base respectively. And the beads are received in a first space defined between the first base and the second base. When the first base and the second base rotate along the rotating axis, the beads propelled by the first orientating column perform a circumferential movement along the rotating axis, and each bead performs self-rotation independently along a self-rotating axis at the same time. Moreover, the rotating axis is parallel to the self-rotation axis.

According to an embodiment of the present invention, the exfoliator comprises a plurality of the first orientating columns.

According to an embodiment of the present invention, the aforementioned first base further includes a first circular surface having a center defined by the first central hole. And the first orientating column is disposed randomly or orderly on a circumference of the first circular surface.

According to an embodiment of the present invention, the aforementioned first base further includes a second circular surface having a center defined by the first central hole, in which a radius of the second circular surface is smaller than a radius of the first circular surface. And the exfoliator further includes a plurality of second orientating columns having two opposite ends, in which the two ends are fixed to the first base and the second base respectively. The second orientating columns are disposed randomly or orderly on a circumference of the second circular surface.

According to an embodiment of the present invention, the aforementioned exfoliator further includes a third base and at least one third orientating column. The third base has a third central hole for allowing the rotating axis to pass therethrough. The second base is located between the first base and the third base. The third orientating column has two opposite ends, in which the opposite two ends are fixed to the second base and the third base respectively.

According to an embodiment of the present invention, the aforementioned first base and the third base respectively includes the first circular surface having the center defined by the first central hole and a third circular surface having a center defined by the third central hole. A radius of the third circular surface is the same as the radius of the first circular surface. A plurality of the first orientating columns are disposed randomly or orderly on the circumference of the first circular surface, and a plurality of the third orientating columns are disposed randomly or orderly on a circumference of the third circular surface.

According to another aspect of the present invention, an exfoliating apparatus including a chamber, the exfoliator and the rotation device is provided. The exfoliator further includes the first base having the first central hole, the second base having the second central hole, at least one first orientating column and a plurality of beads. Besides, the chamber further includes a cavity, and the exfoliator is disposed in the cavity. The rotating axis passes through the central holes, and the two opposite ends of the first orientating column are fixed to the first base and the second base respectively. Moreover, the beads are received in the first space defined between the first base and the second base. When the first base and the second base are driven to rotate along the rotating axis by the rotation device of the exfoliating apparatus, the beads propelled by the first orientating column perform the circumferential movement along the rotating axis, and each bead performs the self-rotation independently along the self-rotating axis at the same time. The rotating axis is parallel to the self-rotation axis. The rotation device includes the rotating axis and a driving unit in which the driving unit electrically connects to the rotating axis. In addition, the exfoliator has a first volume, the beads have a second volume, the second volume is 70 volume percent to 90 volume percent of a second space, and the second space is a difference between the cavity and the first volume.

According to an embodiment of the present invention, the exfoliator comprises a plurality of the first orientating columns.

According to an embodiment of the present invention, the aforementioned first base further includes a first circular surface having a center defined by the first central hole. And the first orientating column is disposed randomly or orderly on a circumference of the first circular surface.

According to an embodiment of the present invention, the aforementioned first base further includes a second circular surface having a center defined by the first central hole, in which a radius of the second circular surface is smaller than a radius of the first circular surface. And the exfoliator further includes a plurality of second orientating columns having two opposite ends, in which the two ends are fixed to the first base and the second base respectively. The second orientating columns are disposed randomly or orderly on a circumference of the second circular surface.

According to an embodiment of the present invention, the aforementioned exfoliator further includes a third base and at least one third orientating column. The third base has a third central hole for allowing the rotating axis to pass therethrough. The second base is located between the first base and the third base. The third orientating column has two opposite ends, in which the two opposite ends are fixed to the second base and the third base respectively.

According to an embodiment of the present invention, the aforementioned first base and third base respectively includes a first circular surface having a center defined by the first central hole and a third circular surface having a center defined by the third central hole. A radius of the third circular surface is the same as the radius of the first circular surface. A plurality of the first orientating columns are disposed randomly or orderly on the circumference of the first circular surface, and a plurality of the third orientating columns are disposed randomly or orderly on the circumference of the third circular surface.

According to a further aspect of the present invention, an exfoliating method is provided. In an embodiment, the aforementioned exfoliating apparatus and a being-exfoliated material in the first space defined between the first base and the second base are provided, in which the being-exfoliated material includes clay, talc, mica, sheet-form aluminum oxide and a mixture thereof. Then, the first base and the second base are driven to rotate along the rotating axis by the rotation device of the exfoliating apparatus. Thus, the beads in the first space propelled by at least one first orientating column perform a circumferential movement along the rotating axis, and each bead performs self-rotation independently along a self-rotating axis at the same time. Moreover, the rotating axis is parallel to the self-rotation axis. In addition, the exfoliator has a first volume, the beads have a second volume, the second volume is 70 volume percent to 90 volume percent of a second space, and the second space is a difference between the cavity and the first volume.

One benefit of the present invention is that there is at least one orientating column between the bases, and when the bases are driven to rotate by the rotating axis, the orientating column is also driven to rotate. Therefore, when the exfoliator, the exfoliating apparatus and the exfoliating method of the present invention are applied to perform the exfoliating operation, the beads are driven by both of the bases and the orientating column. Thus, the beads perform the circumferential movement along the rotating axis, and each bead performs the self-rotation independently along the self-rotation axis. Besides, each bead performs the self-rotation at the different or same angular speed. The probability of the formation of the shearing force increases due to a difference of the angular speed between the two contacted beads, and thus the present invention can provide a better exfoliating efficiency to the sheet-form material.

### BRIEF DESCRIPTION OF THE DRAWINGS

The invention can be more fully understood by reading the following detailed description of the embodiment, with reference made to the accompanying drawings as follows:

FIG. 1 is a stereo diagram showing an exfoliator according to a first embodiment of the present invention.

FIG. 2 is a stereo diagram showing an exfoliator according to a second embodiment of the present invention.

FIG. 3 is a stereo diagram showing an exfoliator according to a third embodiment of the present invention.

FIG. 4 is a stereo diagram showing an exfoliator according to a fourth embodiment of the present invention.

FIG. 5 is a stereo diagram showing an exfoliator according to a fifth embodiment of the present invention.

FIG. 6 is a stereo diagram showing an exfoliating apparatus according to a sixth embodiment of the present invention.

FIG. 7 is a flow chart showing an exfoliating method according to a seventh embodiment of the present invention.

### DETAILED DESCRIPTION

The present invention provides an exfoliating apparatus including a chamber, an exfoliator and a rotation device. The exfoliator includes a base, an orientating column and a plurality of beads. Through the rotation of the exfoliator by the rotation device, the beads in the exfoliator are then propelled by the orientating column and perform both a circumferential movement along a rotating axis as well as an independent self-rotation along a self-rotation axis. Due to a difference of an angular speed between the beads, a shearing force is formed and applied to a being-exfoliated material to produce a sheet-form material.

Reference will now be made in detail to the present embodiments of the invention, examples of which are illustrated in the accompanying drawings. Wherever possible, the same reference numbers are used in the drawings and the description to refer to the same or like parts.

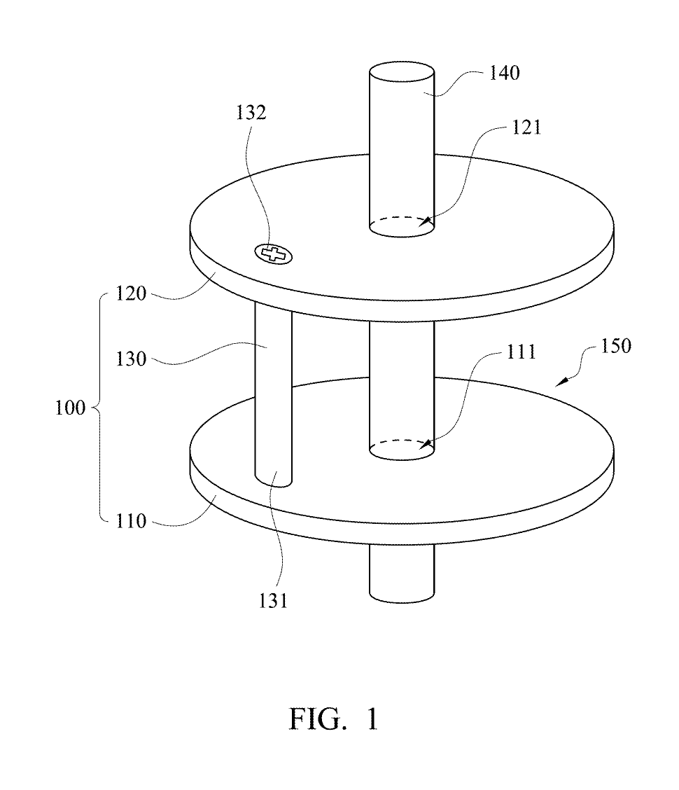

Refer to FIG. 1. FIG. 1 is a stereo diagram showing an exfoliator 100 according to a first embodiment of the present invention. The exfoliator 100 includes a first base 110, a second base 120 and a first orientating column 130. The first base 110 and the second base 120 can have similar shapes, for example, both of the first base 110 and the second base 120 are circular plates. The first base 110 and the second base 120 respectively have a first central hole 111 and a second central hole 121. In an example, a rotating axis 140 can sequentially pass through the first central hole 111 as well as the second central hole 121, so as to connect the first base 110 to the second base 120. Thus, the first base 110 and the second base 120 can be driven to rotate by the rotating axis 140.

A first orientating column 130 has a first end 131 and a second end 132 opposite to the first end 131, in which the two opposite ends are fixed to the first base 110 and the second base 120 respectively. In an example, the first orientating column 130 is perpendicular to the first base 110 and the second base 120, and the first orientating column 130 is screw-fixed to the first base 110 and the second base 120. That is, the first orientating column 130 is located between the first base 110 and the second base 120, and the first orientating column 130 separates the first base 110 from the second base 120 to form a first space 150. The first space 150 can receive the first orientating column 130 and a part of the rotating axis 140, and the first space 150 can also receive a being-exfoliated material (not shown) as well as the beads (not shown) for performing an exfoliating operation. In an example, the being-exfoliated material includes a sheet-form material such as clay, talc, mica, sheet-form aluminum oxide or a mixture thereof.

When the rotating axis 140 is rotating, the rotating axis 140 drives the first base 110, the second base 120 and the first orientating column 130 to rotate. The beads respectively on the first base 110 and the second base 120 are then driven to rotate by the first base 110 and the second base 120. Moreover, the beads near the first orientating column 130 are propelled by the first orientating column 130 and move along a direction of the circumferential movement. As a result, most beads would perform the circumferential movement in a same or a similar direction along the rotating axis 140, and each bead performs the self-rotation independently at a different angular speed along the self-rotation axis (not shown), in which the self-rotation axis is parallel to the rotating axis 140. Since the beads generally move in the same or the similar direction, the difference of the angular speed between the two contacted beads results in a higher probability of applying the shearing force to the being-exfoliated material (e.g. the sheet-form material). In addition, a fluid motion formed after the beads are propelled helps to enlarge a gap between layers, and thus an exfoliating effect of the sheet-form material is accelerated. On the other hand, the sheet-form materials squeeze each other during a propelling operation of the beads, probably leading to exfoliation of the sheet-form materials due to insertion of interlayers into slits, thus the exfoliating effect can be provided. Therefore, the excellent exfoliating effect can be achieved by using the exfoliator 100 of the present invention.

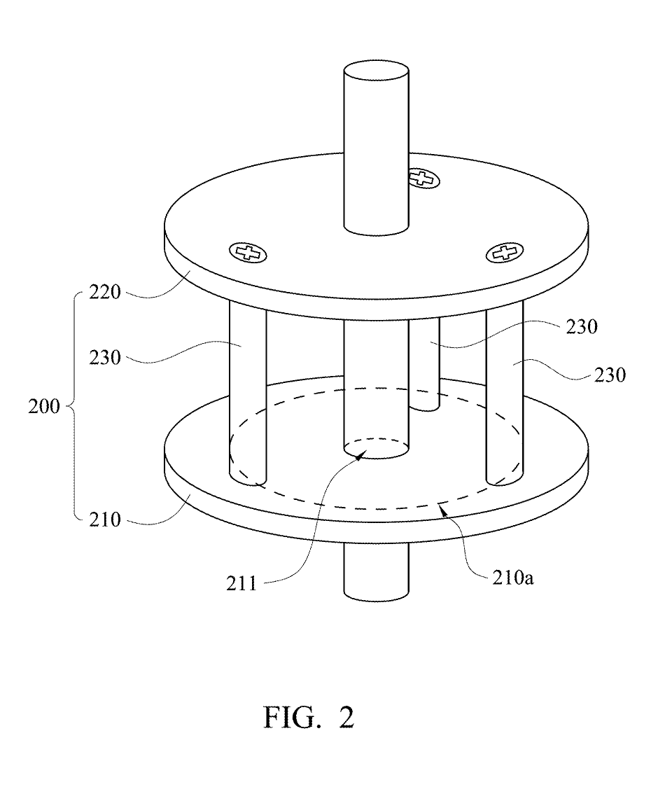

Refer to FIG. 2. FIG. 2 is a stereo diagram showing an exfoliator 200 according to a second embodiment of the present invention. In addition to a first base 210 and a second base 220, the exfoliator 200 further includes a plurality of first orientating columns 230. The first base 210 and the second base 220 of the second embodiment are similar to the first base 110 and the second base 120 of the first embodiment respectively, rather than focusing or mentioning them in details. In an example, the first orientating columns 230 can have various configurations, for example, the first orientating columns 230 are disposed randomly or orderly between the first base 210 and the second base 220. In an exemplary embodiment, a first circular surface 210a is defined on the first base 210, and the first orientating columns 230 are spaced apart from each other in the same distance on a circumference of the first circular surface 210a. The first circular surface 210a is a virtual circular surface defined by a first central hole 211. The first circular surface 210a is a little smaller than the first base 210, and the first circular surface 210a is near an outer edge of the first base 210. It's mentioned that though there are only three first orientating columns 230 in the second embodiment, a number of the orientating column can be changed depending on a requirement of an user, for example, it can be two, four, five or more.

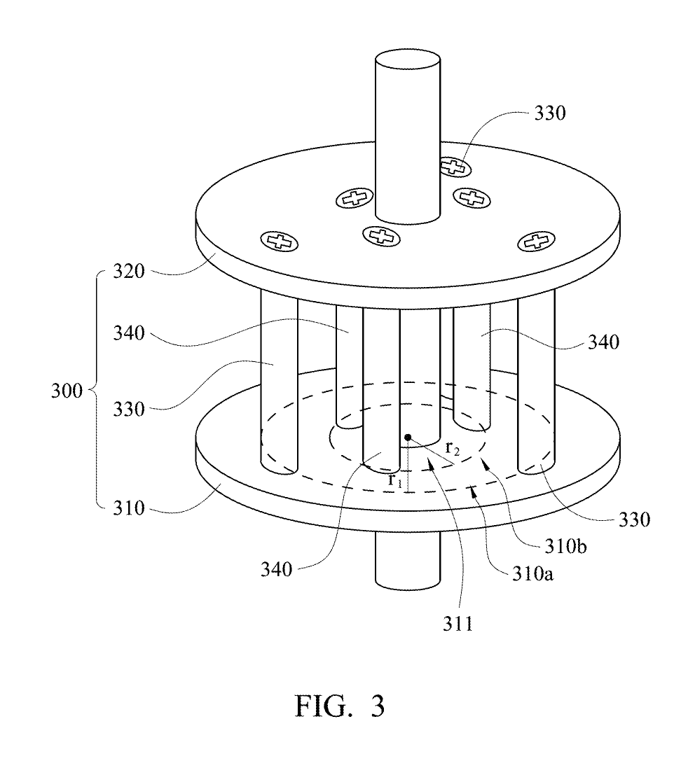

Refer to FIG. 3. FIG. 3 is a stereo diagram showing an exfoliator 300 according to a third embodiment of the present invention. In addition to a first base 310, a second base 320 and a plurality of first orientating columns 330, the exfoliator 300 further includes second orientating columns 340. The first base 310, the second base 320, the first orientating columns 330 and the first circular surface 310a of the exfoliator 300 are similar to the first base 210, the second base 220, the first orientating columns 230 and the first circular surface 210a of the second embodiment respectively, rather than focusing or mentioning them in details. In addition to the defined first circular surface 310a, a second circular surface 310b is defined in the exfoliator 300, and the second orientating columns 340 are spaced apart from each other in the same distance on a circumference of the second circular surface 310b. In an example, a structure and a shape of the second orientating columns 340 are similar to a structure and a shape of the first orientating columns 330. In another example, the first circular surface 310b is a virtual circular surface defined by a first central hole 311, and a radius r₂ of the second circular surface 310b is smaller than a radius r₁ of the first circular surface 310a. When the exfoliator 300 performs the exfoliating operation, the first orientating columns 330 and the second orientating columns 340 have an effect similar to the first orientating column 130 of the first embodiment. The effect of the first orientating column 130 is mentioned in the above paragraph rather than focusing or mentioning them in details.

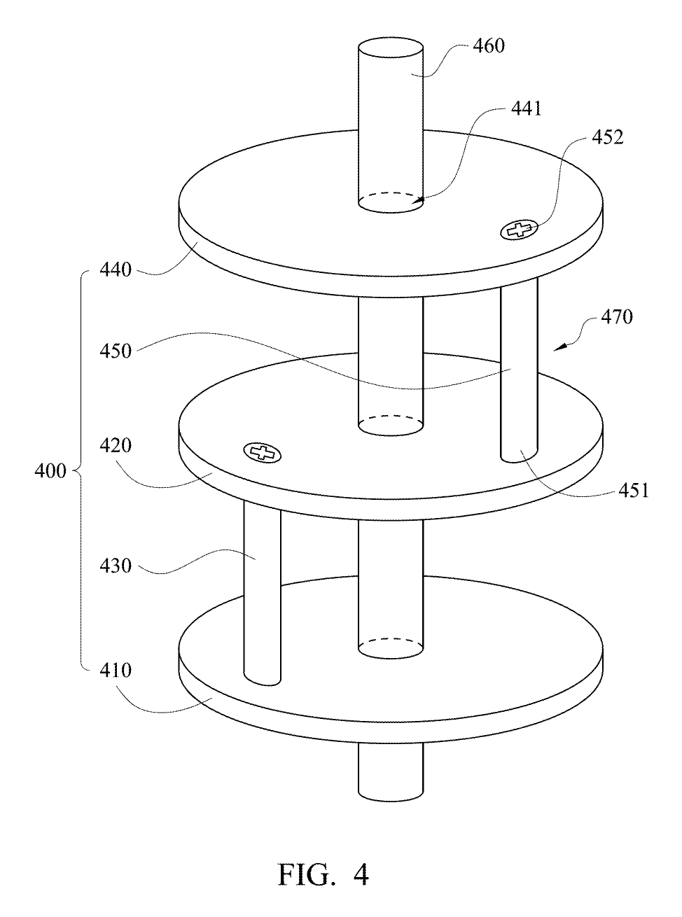

Refer to FIG. 4. FIG. 4 is a stereo diagram showing an exfoliator 400 according to a fourth embodiment of the present invention. In addition to a first base 410, a second base 420 and a first orientating column 430, the exfoliator 400 further includes a third base 440 and a third orientating column 450. The first base 410, the second base 420 and the first orientating column 430 of the exfoliator 400 are similar to the first base 110, the second base 120 and the first orientating column 130 of the first embodiment respectively, rather than focusing or mentioning them in details. The third base 440 can have a similar shape as shapes of the first base 410 or the second base 420. The third base 440 has a third central hole 441 for allowing a rotating axis 460 to pass therethrough. The third orientating column 450 is located between the second base 420 and the third base 440, and separates the second base 420 from the third base 440 to form a first space 470. The first space 470 can receive a part of the rotating axis 460 and the third orientating column 450, and the space 470 can also receive the being-exfoliated material (not shown) as well as the beads (not shown) for performing a propelling operation. In an example, the first base 410, the second base 420 and the third base 440 are arranged sequentially, that is, the second base 420 is disposed between the first base 410 and the third base 440. The third orientating column 450 has a first end 451 and a second end 452 opposite to the first end 451, in which the two ends are fixed to the second base 420 and the third base 440 respectively. In an example, the third orientating column 450 has a similar structure to that of the first orientating column 430. During the propelling operation performed by the exfoliator 400, the first orientating column 430 and the third orientating column 450 have a similar effect to the first orientating column 130 of the first embodiment. The effect of the first orientating column 130 is mentioned in the above paragraph rather than focusing or mentioning them in details.

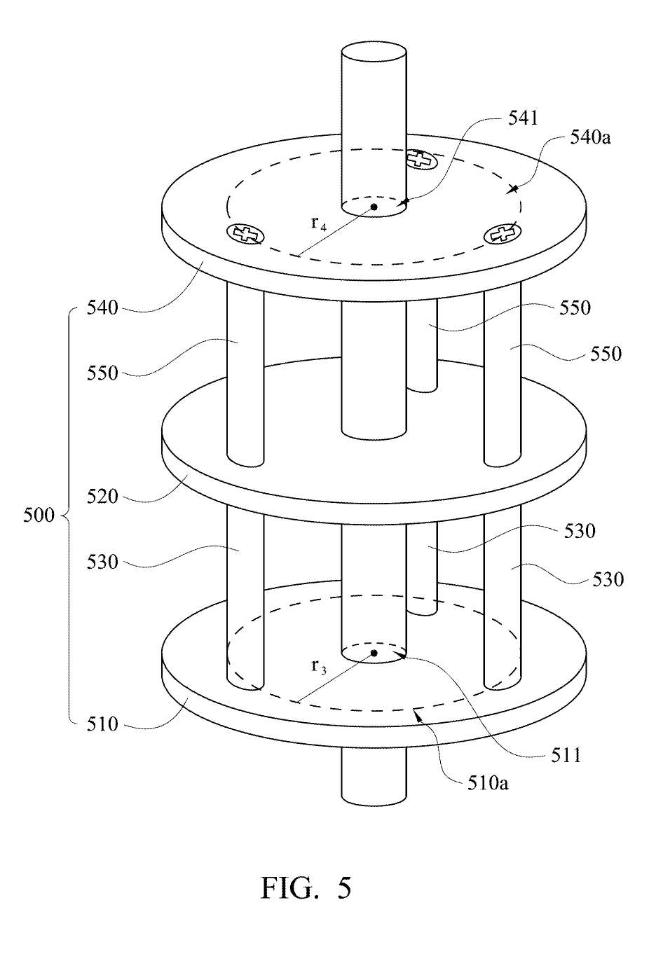

Refer to FIG. 5. FIG. 5 is a stereo diagram showing an exfoliator 500 according to a fifth embodiment of the present invention. In addition to a first base 510, a second base 520 and a plurality of first orientating columns 530, the exfoliator 500 further includes a third base 540 and a plurality of third orientating columns 550. The first base 510, the second base 520, the first orientating column 530, the third base 540 and the third orientating column 550 of the exfoliator 500 are similar to the first base 410, the second base 420, the first orientating column 430, the third base 440 and the third orientating column 450 of the fourth embodiment respectively, rather than focusing or mentioning them in details. The only difference is that several first orientating columns 530 and several third orientating columns 550 are provided in the fifth embodiment. In the exfoliator 500, the first base 510 and the third base 540 respectively include a first circular surface 510a having a center defined by a first central hole 511 and a third circular surface 540a having a center defined by a third central hole 541. In some examples, a radius r₃ of the first circular surface 510a is same as a radius r₄ of the third circular surface 540a. Moreover, the first orientating columns 530 are spaced apart from each other in the same distance on a circumference of the first circular surface 510a, and the third orientating columns 550 are spaced apart from each other in the same distance on a circumference of the third circular surface 540a.

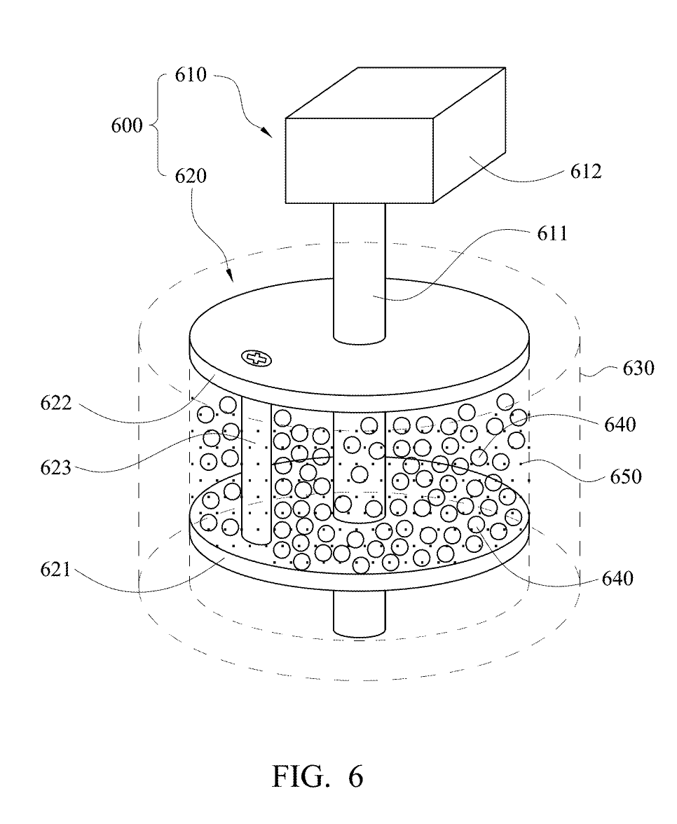

Refer to FIG. 6. FIG. 6 is a stereo diagram showing an exfoliating apparatus 600 according to a sixth embodiment of the present invention, in which a chamber 630 is depicted in a dotted line to clearly reveal an exfoliator 620 inside the chamber 630. The exfoliating apparatus 600 includes a rotation device 610 and the exfoliator 620. In an example, a first orientating column 623 of the exfoliator 620 can be used to propel a plurality of beads 640. During the propelling operation, the beads 640 perform the circumferential movement along the rotating axis 611, and each bead 640 performs the self-rotation independently at the different or the same angular speed along the self-rotation axis. The beads 640 then contact with each other, and the shearing force is caused by the difference of the angular speed. Therefore, a being-exfoliated material 650 can be exfoliated.

The rotation device 610 includes a rotating axis 611 and a driving unit 612, in which the driving unit 612 electrically connects to the rotating axis 611 to drive the rotating axis 611 to rotate. The exfoliator 620 includes a first base 621, the second base 622, at least one orientating column 623 and a plurality of beads 640, in which the exfoliator 620 of the exfoliating apparatus 600 in the sixth embodiment of the present invention is similar to the exfoliator 100 in the first embodiment of the present invention respectively, rather than focusing or mentioning them in details. However, it is mentioned that the exfoliator 200, 300, 400 and 500 in the second to fifth embodiment can replace the exfoliator 620 of the exfoliating apparatus 600 in the sixth embodiment.

In an example, the exfoliating apparatus 600 further includes the chamber 630 and the chamber 630 further includes a cavity (not shown). In an exemplary embodiment, the chamber 630 is a little larger than the exfoliator 620, and the cavity of the chamber 630 can receive several beads 640 and the exfoliator 620. The exfoliator 620 has a first volume, the beads 640 have a second volume, and the second volume is 70 volume percent to 90 volume percent of a second space (not shown), in which the second space is a difference between the cavity and the first volume.

If the second volume is greater than 90 volume percent of the second space, the beads 640 are arranged too closely, leading to the poor exfoliating efficiency. On the other hand, if the second volume is less than 70 volume percent of the second space, the beads 640 are arranged too loosely to be restricted the moving direction by the orientating column 623, the probability of the formation of the shearing force decreases, resulting in the poor exfoliating efficiency.

It is mentioned that the number of the orientating columns is proportional to the number of the beads, that is, the more the beads are, the more the orientating columns can be arranged, and thus the better exfoliating effect is achieved. In addition, a diameter of the orientating is also proportional to a diameter of the beads. The smaller the diameter of the beads is, the smaller the diameter of the orientating column is, and thus the better exfoliating effect is achieved.

Besides, the aforementioned being-exfoliated material 650 can be prepared as a 20 weight percent to 30 weight percent slurry by solvent. For example, the solvent can be water.

The present invention restricts the moving direction of the beads by controlling the remaining volume and the occupied volume of the cavity, the later one of which is occupied by the orientating column and the beads, so as to provide the main effect from the shearing force but not from other interferences such as a collision force and an agitating force.

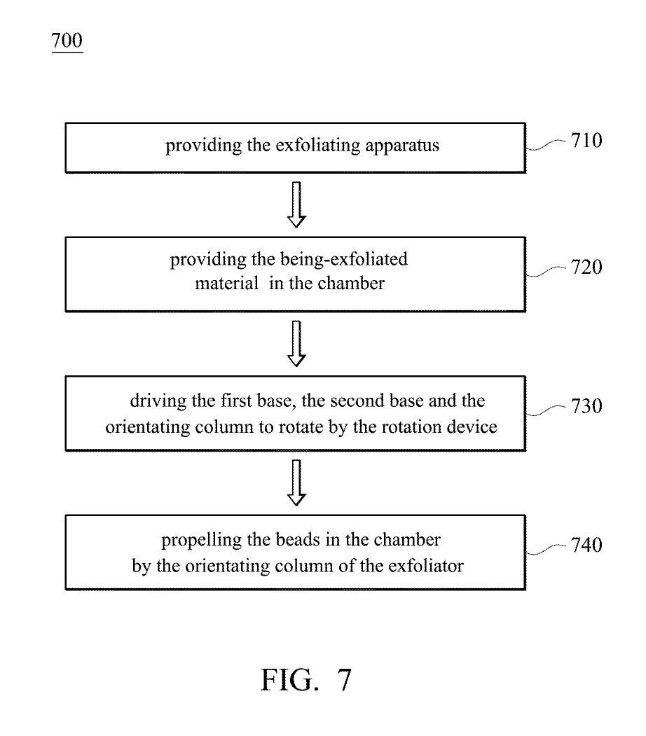

The following is an example to describe an exfoliating method that uses the exfoliating apparatus 600 including the chamber 630. Refer to FIG. 6 and FIG. 7. FIG. 7 is a flow chart showing the exfoliating method 700 according to a seventh embodiment of the present invention. In the method 700, a step 710 is to provide the exfoliating apparatus 600. Then, a step 720 is to provide the being-exfoliated material 650 in the chamber 630. Thereafter, a step 730 is to drive the first base 621, the second base 622 and the orientating column 623 to rotate by the rotation device 610. Then, a step 740 is to propel the beads 640 in the chamber 630 by the orientating column 623 of the exfoliator 620. The beads 640 propelled by the orientating column 623 perform the circumferential movement along the rotating axis 611, and each of the beads 640 performs the self-rotation independently along the self-rotation axis. The self-rotation can have the different angular speed, and the beads 640 contact with each other. Thus, the beads 640 can provide the shearing force to the being-exfoliated material 650. The shearing force from the beads 640 is applied to the being-exfoliated material 650 to form the exfoliating effect, and thus the being-exfoliated material 650 with a laminated structure can be flakily exfoliated. Therefore, the better exfoliating effect can be achieved by applying the method 700 of the seventh embodiment of the present invention to the being-exfoliated material 650.

Refer to FIG. 6. In an example, the exfoliating apparatus 600 in the sixth embodiment of the present invention can perform the exfoliating operation in either batch type or continuous type, and in a direction that the rotating axis 611 moves perpendicular to the ground (hereinafter as a vertical operation) or in a direction that is horizontal to the ground (hereinafter as a horizontal operation).

In an exemplary embodiment, a prepared slurry of the being-exfoliated material 650 of a sheet-form aluminum oxide material and 3 mm beads 640 of yttria stabilized zirconia were put into the chamber 630, in which a dimension of the sheet-form aluminum oxide material was 2 μm to 20 μm. Thereafter, a batch-type vertical operation was performed and the rotating axis 611 rotated at a rotary rate of 300 rpm for 60 minutes to 90 minutes. The particle size of the being-exfoliated material 650 was reduced to less than 1 μm after exfoliated, and the abundance of the sheet-form aluminum oxide material was kept at 50%-80%. The parameters and the results of the batch-type vertical operation are shown in table 1 rather than focusing or mentioning them in details.

TABLE 1

Example

| vertical operation/batch type | | 1 | 2 |
|---|---|---|---|
| Orientating | Amount | 3 | 6 |
| column | Diameter(mm) | 8 | 8 |
| Bead | Type | Yttria | Yttria |
| | | Stabilized | Stabilized |
| | | Zirconia | Zirconia |
| | Diameter(mm) | 3 | 3 |
| Exfoliating | Time(min) | 90 | 60 |
| parameter | Rotary rate(rpm) | 300 | 300 |
| concentration of the slurry of the | | 20 | 20 |
| material to be exfoliated(wt. %) | | | |
| Evaluation | particle size after | <1 | <1 |
| method | exfoliated(μm) | | |
| | percentage of the sheet | ~50 | ~80 |
| | form material(%) | | |

In another exemplary embodiment, the prepared slurry of the being-exfoliated material 650 of the sheet-form aluminum oxide material and the 0.3 mm beads 640 of yttria stabilized zirconia were put into the chamber 630, in which the dimension of the sheet-form aluminum oxide material was 2 μm to 20 μm. The batch-type horizontal operation was then performed and the rotating axis 611 rotated at a rotary rate of 500 rpm to 700 rpm for 15 minutes to 25 minutes. The particle size of the being-exfoliated material 650 was reduced to less than 1 μm after exfoliated, and the abundance of the sheet-form aluminum oxide material was kept at 50.75% to 86.4%. The parameters and the results of the batch-type horizontal operation are shown in table 2 rather than focusing or mentioning them in details.

TABLE 2

| | | Example | | | |
|---|---|---|---|---|---|
| horizontal operation/batch type | | 1 | 2 | 3 | 4 |
| Orientating | Amount | 3 | 3 | 3 | 6 |
| column | Diameter(mm) | 8 | 8 | 8 | 8 |
| Bead | Type | Yttria | Yttria | Yttria | Yttria |
| | | Stabilized | Stabilized | Stabilized | Stabilized |
| | | Zirconia | Zirconia | Zirconia | Zirconia |
| | Diameter(mm) | 0.3 | 0.3 | 0.3 | 0.3 |
| Exfoliating | Time(min) | 15 | 5 | 5 | 5 |
| parameter | Rotary | 500 | 500 | 700 | 500 |
| | rate(rpm) | | | | |
| concentration of the slurry of the | | 20 | 30 | 20 | 20 |
| Evaluation | particle size after | <1 | <1 | <1 | <1 |
| method | exfoliated(μm) | | | | |
| | percentage of | 50.75 | 73.4 | 73.1 | 86.4 |
| | the sheet form | | | | |
| | material(%) | | | | |

In a further exemplary embodiment, the prepared slurry of the being-exfoliated material 650 of a sheet-form aluminum oxide material and the 0.3 mm beads 640 of yttria stabilized zirconia were put into the chamber 630, in which the dimension of the sheet-form aluminum oxide material was 2 μm to 20 μm. Besides, the exfoliator 620 was equipped with 6 orientating columns 623. A continuous-type horizontal operation was then performed and the rotating axis 611 rotated at a rotary rate of 500 rpm for 40 minutes. The particle size of the being-exfoliated material 650 was reduced to less than 1 μm after exfoliated, and the abundance of the sheet-form aluminum oxide material was kept at 67.7%.

According to the aforementioned content, the exfoliating apparatus in the embodiment of the present invention is to drive the beads to move in the same or the similar direction by the orientating column of the exfoliator in the exfoliating apparatus, so as to increase the probability of the formation of the shearing force when the beads with the different or same angular speed contact each other. Therefore, a better exfoliating effect can be achieved through the exfoliating method of the present invention, and it is exactly applicable for the exfoliating operation of the sheet-form material. On the other hand, according to the aforementioned description, the exfoliating method of the present invention also has a grinding effect to reduce the particle size of the being-exfoliated material 650.

Although the present invention has been described in considerable detail with reference to certain embodiments thereof, other embodiments are possible. Therefore, the spirit and scope of the appended claims should not be limited to the description of the embodiments contained herein.

What is claimed is:

1. An exfoliator, comprising:
a first base having a first central hole for allowing a rotating axis to pass therethrough;
a second base having a second central hole for allowing the rotating axis to pass therethrough;
at least one first orientating column having two opposite ends, wherein the two ends are fixed to the first base and the second base respectively; and
a plurality of beads received in a first space defined between the first base and the second base, and
wherein when the first base and the second base rotate along the rotating axis, the beads are propelled by the first orientating column to perform a circumferential movement along the rotating axis, each of the beads performs self-rotation independently along a self-rotating axis at the same time, and the rotating axis is parallel to the self-rotating axis.

2. The exfoliator of claim 1, wherein the exfoliator comprises a plurality of the first orientating columns.

3. The exfoliator of claim 2, wherein the first base further comprises a first circular surface having a center defined by the first central hole, and wherein the first orientating columns are disposed randomly or orderly on a circumference of the first circular surface.

4. The exfoliator of claim 3, wherein the first base further comprises a second circular surface having a center defined by the first central hole, and wherein a radius of the second circular surface is smaller than a radius of the first circular surface, and the exfoliator further comprises:
a plurality of second orientating columns, wherein each of the second orientating columns has two opposite ends fixed to the first base and the second base respectively, and the second orientating columns are disposed randomly or orderly on a circumference of the second circular surface.

5. The exfoliator of claim 1, further comprising:
a third base having a third central hole for allowing the rotating axis to pass therethrough, wherein the second base is located between the first base and the third base; and
at least one third orientating column having two opposite ends, wherein the two ends of the third orientating column are fixed to the second base and the second base respectively.

6. The exfoliator of claim 5, wherein the first base and the third base respectively comprise a first circular surface having a center defined by the first central hole, a third circular surface having a center defined by the third central hole, and a radius of the third circular surface is same as a radius of the first circular surface, and wherein a plurality of the first orientating columns are disposed randomly or orderly on the circumference of the first circular surface, and a plurality of the third orientating columns are disposed randomly or orderly on a circumference of the third circular surface.

7. An exfoliating apparatus comprising:
a chamber comprising a cavity;
an exfoliator disposed in the cavity, wherein the exfoliator comprises:
a first base having a first central hole for allowing a rotating axis to pass therethrough;
a second base having a second central hole for allowing the rotating axis to pass therethrough;
at least one first orientating column having two opposite ends, wherein the two ends are fixed to the first base and the second base respectively; and
a plurality of beads received in a first space defined between the first base and the second base, wherein when the first base and the second base rotate along the rotating axis, the beads are propelled by the first orientating column to perform a circumferential movement along the rotating axis, each of the beads performs self-rotation independently along a self-rotating axis at the same time, and the rotating axis is parallel to the self-rotating axis; and
a rotation device disposed out of the cavity, wherein the rotation device comprises:
the rotating axis; and
a driving unit electrically connected to the rotating axis, and
wherein the exfoliator has a first volume, the beads have a second volume, the second volume is 70 volume percent to 90 volume percent of a second space, and the second space is a difference between the cavity and the first volume.

8. The exfoliating apparatus of claim 7, wherein the exfoliator comprises a plurality of the first orientating columns.

9. The exfoliating apparatus of claim 8, wherein the first base further comprises a first circular surface having a center defined by the first central hole, and wherein the first orientating columns are disposed randomly or orderly on a circumference of the first circular surface.

10. The exfoliating apparatus of claim 9, wherein the first base further comprises a second circular surface having a center defined by the first central hole, and wherein a radius of the second circular surface is smaller than a radius of the first circular surface, and the exfoliator further comprises:
a plurality of second orientating columns, wherein each of the second orientating columns has two opposite ends fixed to the first base and the second base respectively, and the second orientating columns are disposed randomly or orderly on a circumference of the second circular surface.

11. The exfoliating apparatus of claim 7, further comprising:
a third base having a third central hole for allowing the rotating axis to pass therethrough, wherein the second base is located between the first base and the third base; and
at least one third orientating column having two opposite ends, wherein the two ends of the third orientating column are fixed to the second base and the second base respectively.

12. The exfoliating apparatus of claim 11, wherein the first base and the third base respectively comprises a first circular surface having a center defined by the first central hole, a third circular surface having a center defined by the third central hole, and a radius of the third circular surface is same as the radius of the first circular surface, and wherein a plurality of the first orientating columns are disposed randomly or orderly on the circumference of the first circular surface, and a plurality of the third orientating columns are disposed randomly or orderly on a circumference of the third circular surface.

13. An exfoliating method, comprising:
providing an exfoliating apparatus described in claims 7 to 12;
providing a being-exfoliated material in a first space defined between a first base and a second base of the exfoliating apparatus, wherein the being-exfoliated material comprises clay, talc, mica, sheet-form aluminum oxide or a mixture thereof;
driving the first base and the second base to rotate along a rotating axis by a rotation device of the exfoliating apparatus; and
propelling a plurality of beads in the first space by at least one orientating column of an exfoliator, wherein each of the beads performs a circumferential movement along the rotating axis, and the beads perform individual self-rotation along a self-rotating axis at the same time, so as to exfoliate the being-exfoliated material, and wherein the rotating axis is parallel to the self-rotating axis, and
wherein the exfoliator has a first volume, and the beads have a second volume, the second volume is 70 volume percent to 90 volume percent of a second space, and the second space is a difference between the cavity and the first volume.
